(19) United States
(12) Patent Application Publication
(10) Pub. No.: US 2022/0369607 A1
(43) Pub. Date: Nov. 24, 2022

(54) CONTROLLABLE AND STABLE SINKING/FLOATING SYSTEM FOR CAGE AQUACULTURE

(71) Applicant: NATIONAL TAIWAN OCEAN UNIVERSITY, KEELUNG CITY (TW)

(72) Inventors: CHUNG-CHENG CHANG, KEELUNG CITY (TW); CHEN-CHOU LIN, TAIPEI CITY (TW); TAI-CHI CHANG, TAICHUNG CITY (TW); BO-YUAN CHEN, NEW TAIPEI CITY (TW); HSUAN-CHIEH WANG, TAIPEI CITY (TW)

(21) Appl. No.: 17/324,236

(22) Filed: May 19, 2021

(51) Int. Cl. A01K 61/65; G08C 17/02

(52) U.S. Cl. CPC A01K 61/65; G08C 17/02; H04N 7/183

(57) ABSTRACT

A controllable and stable sinking/floating system for cage aquaculture is illustrated, which has a net cage and the sinking/floating units. The net cage comprises a frame and a net body installed on the frame. The sinking/floating units are installed on the frame, each of the sinking/floating units comprises a water storage chamber and a liquid flow controller, the water storage chamber has an inlet and an outlet, and the liquid flow controller controls water to flow out via the outlet from the water storage chamber or to flow into the water storage chamber via the inlet. When the water flows out via the outlet from the water storage chamber, the sinking/floating unit floats; and when the water flows into the water storage chamber via the inlet, the sinking/floating unit sinks.

### BACKGROUND

### 1. Technical Field

The present disclosure relates to the technical field of an aquaculture system, and particularly relates to a controllable and stable sinking/floating system for cage aquaculture.

### 2. Related Art

With the rapid expansion of the global population, the rate of consumption of edible aquatic products has accelerated with the increase in the total population. In addition, in recent years, due to the overfishing, the pollution of the marine environment and the impact of global climate change, natural fishery resources are increasingly scarce, and in order to make up for the huge demand for edible aquatic products, global aquaculture fisheries accordingly grows rapidly.

Due to the small land area of Taiwan, the onshore fish farming industry is unable to meet domestic demand, and the over-pumping of groundwater for the development of onshore fish farms will cause many shortcomings of stratum subsidence. Therefore, the cage aquaculture industry in open seas has gradually attracted attention, and in order to prevent the destruction of the net cage due to swells generated by the typhoon, a conventional sinking/floating net cage is proposed. The conventional sinking/floating net cage is composed of a net bag, a frame and an annular hollow tube. The net bag is a fully enclosed bag body, the frame is made of a sink body, the net bag is fastened to the frame, and the ring-shaped hollow pipe is looped around the frame. The conventional sinking/floating net cage requires a lot of manpower and time to perform the sinking/floating operation. In addition, when the conventional sinking/floating net cage sinks, if the whole conventional sinking/floating net cage is subjected to different gravity directions, it is easy to make the frame tilt angle too large, which will cause the net bag volume to decrease rapidly. When the movement space of the fish is reduced, the fish will be easy injured due to collision. In addition, the conventional sinking/floating net cage is not equipped with a monitoring system, and it is impossible to know the relevant information near the water field in time, so that, it cannot deal with temporary potential crises or it is difficult to judge the timing for floating the conventional sinking/floating net cage.

### SUMMARY

To solve the technical problems in the prior art, the objective of the present disclosure provides a controllable and stable sinking/floating system for cage aquaculture. When it is required to sink or float the net cage, the net cage can stably sink or float, so as to prevent the net cage from being titled or overturned when the net cage moves, and thus the growth of the aquatic product is not affected.

According to one embodiment of the present disclosure, a controllable and stable sinking/floating system for cage aquaculture is provided, which has a net cage and the sinking/floating units. The net cage comprises a frame and a net body installed on the frame. The sinking/floating units are installed on the frame, each of the sinking/floating units comprises a water storage chamber and a liquid flow controller, the water storage chamber has an inlet and an outlet, and the liquid flow controller controls water to flow out via the outlet from the water storage chamber or to flow into the water storage chamber via the inlet. When the water flows out via the outlet from the water storage chamber, the sinking/floating unit floats up; and when the water flows into the water storage chamber via the inlet, the sinking/floating unit sinks down.

According to the above features, the sinking/floating unit further comprises a depth sensor and a controller, the depth sensor and the liquid flow controller are electrically connected to the controller, the depth sensor detects a underwater depth of the sinking/floating unit to generate a depth signal, the depth signal is transmitted to the controller, the controller compares the depth signal to a setting value, and drives the liquid flow controller according to a comparison result.

According to the above features, the controller comprises a first processing module, a programmable controller module electrically connected to the first processing module, and a first wireless communication module electrically connected to the first processing module, the depth signal is transmitted to the first processing module and compared to the setting value set in the programmable controller module, and the depth signal is transmitted via the first wireless communication module.

According to the above features, the sinking/floating unit further comprises a satellite positioning unit, and the satellite positioning unit detects a satellite signal to generate a geographic coordinate position signal, and the geographic coordinate position signal is transmitted via the first wireless communication module.

According to the above features, the controllable and stable sinking/floating system for cage aquaculture further comprises a marine environment monitoring host, the marine environment monitoring host comprises a second processing module, a data analyzing unit, a parameter setting unit and a second wireless communication module, the depth signal, the geographic coordinate position signal and the acceleration signal are transmitted to the second processing module via the second wireless communication module, the second processing module transmits the depth signal and the geographic coordinate position signal to the data analyzing unit, the parameter setting unit generates a control signal according to an analysis result, and the control signal is transmitted to the sinking/floating units via the second wireless communication module.

According to the above features, the controllable and stable sinking/floating system for cage aquaculture further comprises an onshore processing center the marine environment monitoring host is installed in the onshore processing center, the onshore processing center is linked to the sinking/floating units via a network, and the depth signal, the geographic coordinate position signal and the acceleration signal are transmitted to the onshore processing center via the network.

According to the above features, the controllable and stable sinking/floating system for cage aquaculture further comprises a cloud data center, the cloud data center is linked to the onshore processing center, and the depth signal, the geographic coordinate position signal and the acceleration signal are transmitted via the onshore processing center to the cloud data center for computing.

According to the above features, the controllable and stable sinking/floating system for cage aquaculture further comprises an offshore station, the marine environment monitoring host is installed in the offshore station, the sinking/floating units are linked to the offshore station via the network, and the depth signal, the geographic coordinate position signal and the acceleration signal are transmitted to the offshore station via the network.

According to the above features, the controllable and stable sinking/floating system for cage aquaculture further comprises a work boat, the marine environment monitoring host is installed in the work boat, the work boat receives the depth signal, the geographic coordinate position signal and the acceleration signal via the network, and the control signal is transmitted to the sinking/floating units via the network.

According to the above features, the controllable and stable sinking/floating system for cage aquaculture further comprises multiple anchors, and each of the anchors is connected to the net cage via a connection part and sunken underwater.

The controllable and stable sinking/floating system for cage aquaculture of the present disclosure is provided by setting multiple sinking/floating units on the net cage, and these sinking/floating units can be arranged in pairs on the net cage, so that the net cage for cage aquaculture can be stabilized and float up or sink down in a balanced state, so as to prevent the net cage for cage aquaculture from tilting or overturning, which causes damage to aquatic products and affects the growth of the aquatic products.

### BRIEF DESCRIPTIONS OF DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 is a three-dimensional view of a controllable and stable sinking/floating system for cage aquaculture according to an embodiment of the present disclosure.

FIG. 2 is a three-dimensional view of a controllable and stable sinking/floating system for cage aquaculture according to another embodiment of the present disclosure.

FIG. 3 is an explosive diagram of a part of the controllable and stable sinking/floating system for cage aquaculture of FIG. 1.

FIG. 4 is an enlarged view of a part of FIG. 3.

FIG. 5 is a three-dimensional view of a controllable and stable sinking/floating system for cage aquaculture according to another embodiment of the present disclosure.

FIG. 6 is a function block diagram of a controllable and stable sinking/floating system for cage aquaculture according to an embodiment of the present disclosure.

FIG. 7 is a schematic diagram showing an arrangement of the controllable and stable sinking/floating system for cage aquaculture of the present diagram.

### DESCRIPTIONS OF EXEMPLARY EMBODIMENTS

To understand the technical features, content and advantages of the present disclosure and its efficacy, the present disclosure will be described in detail with reference to the accompanying drawings. The drawings are for illustrative and auxiliary purposes only and may not necessarily be the true scale and precise configuration of the present disclosure. Therefore, the scope of the present disclosure should not be limited to the scale and configuration of the attached drawings.

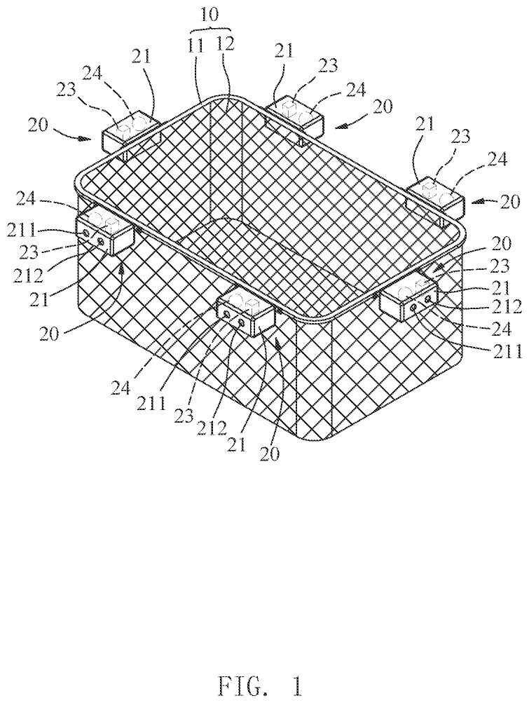

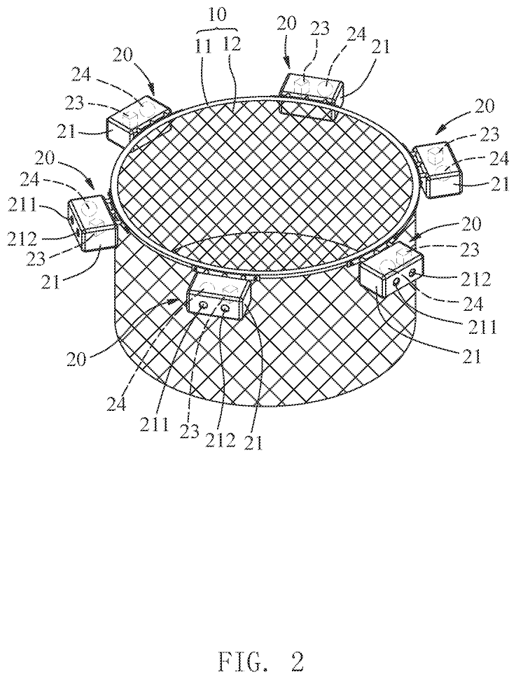

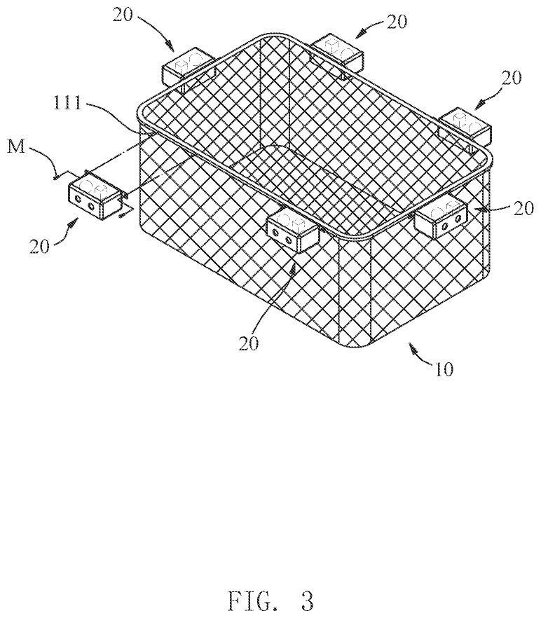

Refer to FIG. 1 through FIG. 4, and all of them illustrate the controllable and stable sinking/floating system for cage aquaculture according to embodiments of the present disclosure. The controllable and stable sinking/floating system 100 for cage aquaculture comprises a net cage 10 and multiple sinking/floating units 20. The net cage 10 comprises a frame 11 and a net body 12 installed on the frame 11. The frame 11 forms a closed shape, such as a rectangle as shown in FIG. 1 or a circle as shown in FIG. 2, and the net body 12 is suspended on the frame 11, thereby trapping the aquatic products in the net body 12.

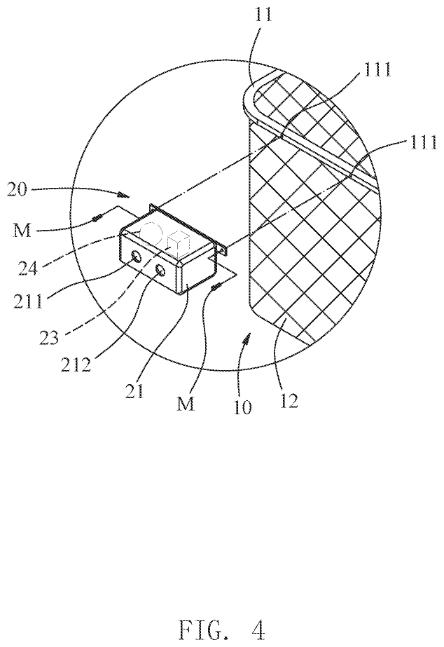

The sinking/floating units 20 can be arranged in frame 11 opposite to each other. In order to keep the frame 11 of the net cage 10 horizontal when floating up or sinking down, to prevent the net cage 10 from tilting. The sinking/floating units 20 are installed on the frame 11 in a symmetrical manner, as shown in FIG. 1, and the opposite sides of the frame 11 are provided with an equal number of the sinking/floating units 20 at the symmetrical positions, or as shown in FIG. 2, an even number of the sinking/floating units 20 are installed on the circular frame 11 with equal angular distances. As shown in FIG. 4, the sinking/floating unit 20 is fixed to the lock hole 111 of the frame 11 by using a screw bolt M.

As shown in FIG. 4, each sinking/floating unit 20 comprises a water storage chamber 21 and a liquid flow controller 22, and has an inlet 211 and an outlet 212. The liquid flow controller 22 includes a valve body and a water pump, and the valve body and the water pump are respectively arranged on the inlet 211 and the outlet 212. According to Archimedes' principle, the weight of the same volume of water discharged by the sinking/floating unit 20 is the buoyancy acting on the sinking/floating unit 20. Therefore, when controlling the sinking of the net cage 10, the valve body of the sinking/floating unit 20 opens to allow water to enter the water storage chamber 21 via the inlet 211, increasing the weight of the floating-sinking unit 20, and making the weight greater than the buoyancy, the sinking/floating unit 20 begins to sink. When the predetermined depth is reached, the water pump is activated to discharge part of the water via the outlet 212, so that the sum of the weight of the multiple sinking/floating units 20 and the weight of the net cage 10 is equal to the sum of the buoyancy forces acting on the sinking/floating units 20, and the net cage 10 can be positioned at any set position underwater. When the net cage 10 is controlled to float up, the water pump is activated to discharge all the water via the outlet 212, thereby making the sum of the buoyancy acting on the sinking/floating units 20 greater than the sum of the weight of the sinking/floating units 20 and the weight of the net cage 10, the net cage 10 can float up to the water surface.

In another embodiment, in addition to the water storage chamber 21, the sinking/floating unit 20 further comprises a gas storage chamber. The gas storage chamber stores high-pressure gas and communicates with the water storage chamber 21 via a gas flow port, and a gas flow controller is set at the gas flow port. The gas flow controller comprises a gas pump and a valve body. When the sinking/floating unit 20 floats up, the valve body is opened, so that the high-pressure gas in the gas storage chamber enters the water storage chamber 21 through the gas flow port and discharges water via the outlet 212. When the sinking/floating unit 20 sinks down, the gas pump causes the gas in the water storage chamber 21 to return to the gas storage chamber through the gas flow port, and the water enters the water storage chamber 21 via the inlet 211.

In another embodiment, in addition to the sinking/floating unit 20, the frame 11 may be surrounded by a floating tube, and a hollow housing space is formed inside the floating tube. The floating tube provides buoyancy on the water to make the frame 11 float on the water surface. It is helpful for farmers to stand on frame 11 and work.

As shown in FIG. 4, the sinking/floating unit 20 further comprises a depth sensor 23 and a controller 24. The depth sensor 23 and the liquid flow controller 22 are electrically connected to the controller 24. The depth sensor 23 detects the underwater depth of the sinking/floating unit 20 and generates a depth signal. The depth sensor 23 can be a piezoelectric IC or a strain gauge, and the value of the underwater depth (i.e. the depth under the water surface) is obtained by detecting the water pressure. The depth signal is transmitted to the controller 24, and the controller 24 compares the depth signal to a setting value, and drives the liquid flow controller 22 according to the comparison result. The setting value can be the expected sinking depth of the net cage. According to the comparison result of the depth signal and the setting value, the controller 24 controls the liquid flow controller 22 to make water flow into or out of the water storage chamber 21 of the sinking/floating unit 20 and make the net cage 10 sink down or float up.

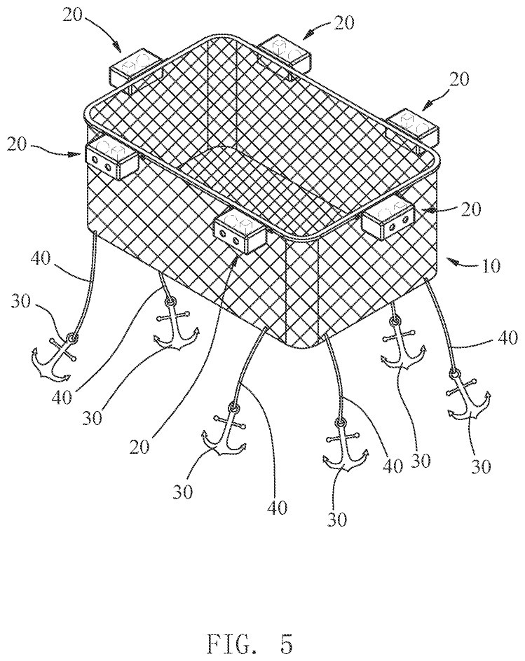

Please refer to FIG. 5, which shows the controllable and stable sinking/floating system for cage aquaculture of another embodiment. This embodiment has partly the same structure as the previous embodiment, so the same components are given the same symbols and their descriptions are omitted. The controllable and stable sinking/floating system for cage aquaculture in such embodiment further comprises a plurality of anchors 30, and the anchors 30 are respectively connected to the net cage 10 through the connection parts 40, wherein the length of the connection part 40 is sufficient to keep the anchor 30 sunken underwater and make the net cage 10 float up or sink down by using the sinking/floating units 20. The anchor 30 can be an iron anchor, a cement block or a cage bag with stones, and the connection part 40 can be an iron chain or a cable. The main function of anchor 30 is to fix the net cage 10 in the sea area planned by the aquaculture industry to prevent the net cage 10 from drifting out of the planned sea area under the influence of waves and ocean currents.

In another embodiment, a counterweight system is further provided, which is arranged on the side of the net body 12 being opposite to the frame 11, and the counterweight system is selected from a counterweight structure of a heavy hammer or a net frame. The counterweight system is mainly used to maintain the volume rate of the net body to keep the set breeding density, so as to avoid that when the net body deformation rate is too large, it will cause the fish to panic and collide with each other, or cause the fish to collide with the net bag and get injured or even die.

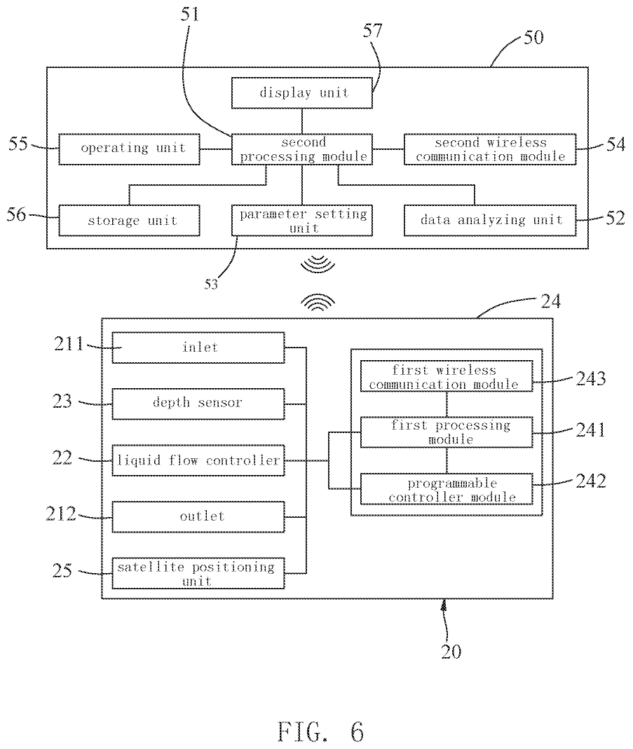

Please refer to FIG. 6, which is a system block diagram of the controllable and stable sinking/floating system for cage aquaculture of the present disclosure. As shown in FIG. 6, the controller 24 comprises a first processing module 241, a programmable controller module 242 electrically connected to the first processing module 241, and a first wireless communication module 243 electrically connected to the first processing module 241. The depth signal is transmitted from the depth sensor 23 to the first processing module 241 and compared to the setting value set in the programmable controller module 242, and the depth signal is transmitted to the marine environment monitoring host 50 described later through the first wireless communication module 243. The programmable controller module 242 can set programs and parameter values corresponding to various conditions. The first processing module 241 loads and executes the program codes and parameter values in the programmable controller module 242 corresponding to various conditions. The sinking/floating unit 20 further comprises a satellite positioning unit 25, which detects the satellite signal and generates a geographic coordinate position signal. The geographic coordinate position signal is transmitted to the marine environment monitoring host 50 described later through the first wireless communication module 243.

In another embodiment, in addition to the depth sensor 23, the sinking/floating unit 20 further comprises an accelerometer, which is electrically connected to the first processing module 241 of the controller 24, the accelerometer detects a movement state of the sinking/floating unit 20 to generate an acceleration signal. The acceleration signal is transmitted to the marine environment monitoring host 50 described later through the first processing module 241 and the first wireless communication module 243, and the farmer can use the acceleration signal to assist in determining the movement state of the net cage.

In another embodiment, the sinking/floating unit 20 further comprises a camera device, which is electrically connected to the liquid flow controller 22, the depth sensor 23, the programmable controller module 242, the first processing module 241, and the first wireless communication module 243. In implementation, the camera device captures an image of a group of fish underwater, and the image of the group of fish is converted into an image signal, which is sent to the marine environment monitoring host 50 described later through the first processing module 241 and the first wireless communication module 243, for remote observation of the state of the group of fish.

As shown in FIG. 6, the marine environment monitoring host 50 comprises a second processing module 51, a data analyzing unit 52, a parameter setting unit 53, and a second wireless communication module 54, wherein the depth signal, the geographic coordinate position signal, the acceleration signal and the image signal are sent to the marine environment monitoring host 50, and then sent to the second processing module 51 via the second wireless communication module 54. The second processing module 51 sends the depth signal, the geographic coordinate position signal, the acceleration signal and the image signal to the data analyzing unit 52. According to the analysis result, the parameter setting unit 53 generates a control signal, and the control signal is transmitted to the sinking/floating units 20 via the second wireless communication module 54. The control signal is received by the first wireless communication module 243 to control the liquid flow controller 22 or gas flow controller.

The marine environment monitoring host 50 further comprises an operating unit 55, a storage unit 56 and a display unit 57. The marine environment monitoring host 50 collects various data generated by the sinking/floating unit 20 in the aquaculture area, such as the depth signal, the geographic coordinate position signal, the acceleration signal and the image signal. These data are stored in the storage unit 56 via the control of the second processing module 51, or can be browsed and analyzed by the farmer via the display unit 57, and thus, the farmer can operate the operating unit 55 and generate an operating command. The operating command is transmitted to the sinking/floating unit 20 through the first wireless communication module 243 through the second processing module 51 and the second wireless communication module 54. The first processing module 241 and the programmable controller module 242 control the liquid flow controller 22 or the gas flow controller according to the operating command to make the sinking/floating unit 20 float up or sink down. The marine environment monitoring host 50 can receive the acceleration signal generated by the accelerometer according to the movement state of the sinking/floating unit 20 through the second wireless communication module 54, so that the farmer can monitor the acceleration signal of the sinking/floating unit 20 through the marine environment monitoring host 50 and operate the operating unit 55 to control the movement state of the sinking/floating unit 20, and then adjust the tilt angle of the net cage 10 to balance the tilt angle. The farmer can understand the current operating status of the sinking/floating unit 20 through the depth signal and acceleration signal; or the farmer can use the operating unit 55 to control one or more sinking/floating unit 20 to float up, sink down or keep the current operating continuously. In actual implementation, the position of the net cage 10 in the sea can be adjusted according to the temperature, flow rate or water depth suitable for the fish being cultured, or one or more sinking/floating units 20 can be adjusted to float up or sink down according to the direction of the sea current, so that the overall net cage 10 can float up, sink down or tilt to avoid the net cage 10 being directly damaged by the impact of the ocean current. Or alternatively, the parameter setting unit 53 is set to monitor the operating status of the sinking/floating unit 20, or to automatically adjust the operation status of the sinking/floating unit 20.

In another embodiment, the marine environment monitoring host 50 further comprises at least one of a wave sensor, a water temperature sensor, a water quality sensor, and a wind speed sensor. Each sensor monitors the waves, water temperature, water quality, and wind speed in the breeding area, and generates monitoring data of each sensor, and the collected monitoring data of each sensor are stored in the storage unit 56 through the control of the second processing module 51, or through the operating unit 55, the farmer can browse or analyze the wave, water temperature, water quality, wind speed and other monitoring data of the sensors in the breeding area.

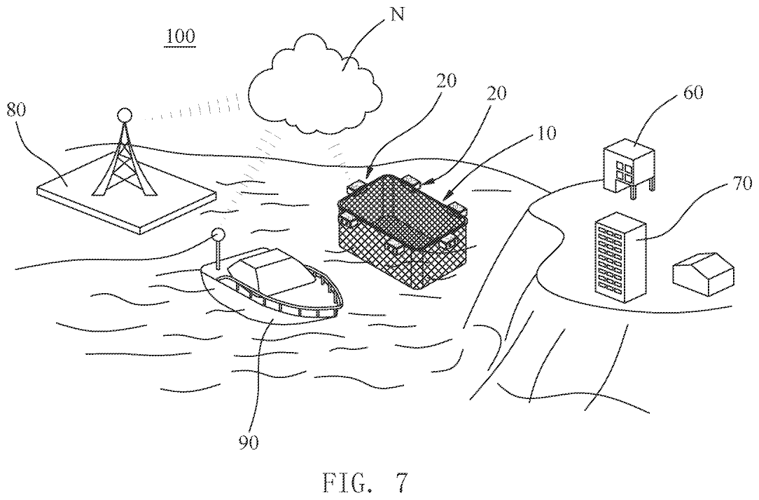

Please refer to FIG. 7, and the controllable and stable sinking/floating system 100 for cage aquaculture of the present disclosure further comprises an onshore processing center 60, a cloud data center 70, an offshore station 80 and a work boat 90. Each sinking/floating unit 20 is linked to the onshore processing center 60, the offshore station 80 and the work boat 90 via the network N, and the cloud data center 70 is linked to the onshore processing center 60 via the network N. The aforementioned marine environment monitoring host 50 can be installed in the onshore processing center 60, the offshore station 80 and the work boat 90. Various data generated by the sinking/floating unit 20 are transmitted to marine environment monitoring host 50 via the network N. Based on various data transmitted by sinking/floating unit 20 and the wave, water temperature, water quality and wind speed detected by the sensors, the marine environment monitoring host 50 analyzes the various data and generates a control signal accordingly, or sends the various data to the cloud data center 70 for storage and big data analysis, wherein the big data analysis can consider the marine environment, aquatic product species and net cage structure to obtain the optimal control solution for controlling the movement of net cage 10.

The controllable and stable sinking/floating system for cage aquaculture of the present disclosure is provided by setting multiple sinking/floating units on the net cage, and these sinking/floating units can be arranged in pairs on the net cage, so that the aquaculture net cage can be stabilized and float up or sink down in a balanced state, so as to prevent the aquaculture net cage from tilting or overturning, causing damage to aquatic products and affecting the growth of the aquatic products. The controllable and stable sinking of the net cage can greatly reduce the manpower and time required to perform the sinking of the net cage body, and can further reduce personnel safety problems caused by manual operations. By using the accelerometer to detect the tilt angle of the floating frame, and the tilt angle range of the floating frame can be reduced and adjusted to avoid the excessive tilt angle of the floating frame when the net cage body sinks down, which will cause the net body volume to decrease rapidly, causing damage to the farmed fish, and even death. According to the monitoring data of various sensors such as water temperature, wave, water quality and wind speed, provided by the marine environment monitoring host, the farmer can determine the timing of the sinking or floating of the net cage body when facing sudden natural disasters or accidents, so as to greatly reduce the loss of the farmer. By using the simple and clear sinking/floating status unit, operating unit and parameter setting unit, the operation interface can be simplified, so that the farmer can quickly become familiar with the system instructions to operate the float to drive the net cage body to float up or sink down.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. A controllable and stable sinking/floating system for cage aquaculture, comprising:
a net cage, comprising a frame and a net body installed on the frame; and
multiple sinking/floating units, installed on the frame, wherein each of the sinking/floating units comprises a water storage chamber and a liquid flow controller, the water storage chamber has an inlet and an outlet, the liquid flow controller controls water to flow out via the outlet from the water storage chamber or to flow into the water storage chamber via the inlet;
wherein when the water flows out via the outlet from the water storage chamber, the sinking/floating unit floats up; and when the water flows into the water storage chamber via the inlet, the sinking/floating unit sinks down.

2. The controllable and stable sinking/floating system for cage aquaculture of claim 1, wherein the sinking/floating unit further comprises a depth sensor and a controller, the depth sensor and the liquid flow controller are electrically connected to the controller, the depth sensor detects a underwater depth of the sinking/floating unit to generate a depth signal, the depth signal is transmitted to the controller, the controller compares the depth signal to a setting value, and drives the liquid flow controller according to a comparison result.

3. The controllable and stable sinking/floating system for cage aquaculture of claim 2, wherein the controller comprises a first processing module, a programmable controller module electrically connected to the first processing module, and a first wireless communication module electrically connected to the first processing module, the depth signal is transmitted to the first processing module and compared to the setting value set in the programmable controller module, and the depth signal is transmitted via the first wireless communication module.

4. The controllable and stable sinking/floating system for cage aquaculture of claim 3, wherein the sinking/floating unit further comprises a camera device, the camera device, the liquid flow controller, the depth sensor, the programmable controller module, the first processing module and the first wireless communication module are electrically connected to each other.

5. The controllable and stable sinking/floating system for cage aquaculture of claim 3, wherein the sinking/floating unit further comprises a satellite positioning unit, and the satellite positioning unit detects a satellite signal to generate a geographic coordinate position signal, and the geographic coordinate position signal is transmitted via the first wireless communication module.

6. The controllable and stable sinking/floating system for cage aquaculture of claim 5, wherein the sinking/floating unit further comprises an accelerometer, the accelerometer is electrically connected to the first processing module of the controller, the accelerometer detects a movement state of the sinking/floating unit to generate an acceleration signal, and the acceleration signal is transmitted via the first wireless communication module.

7. The controllable and stable sinking/floating system for cage aquaculture of claim 6, further comprising a marine environment monitoring host, the marine environment monitoring host comprises a second processing module, a data analyzing unit, a parameter setting unit and a second wireless communication module, the depth signal, the geographic coordinate position signal and the acceleration signal are transmitted to the second processing module via the second wireless communication module, the second processing module transmits the depth signal and the geographic coordinate position signal to the data analyzing unit, the parameter setting unit generates a control signal according to an analysis result, and the control signal is transmitted to the sinking/floating units via the second wireless communication module.

8. The controllable and stable sinking/floating system for cage aquaculture of claim 7, wherein the marine environment monitoring host further comprises at least one of a wave sensor, a water temperature sensor, a water quality sensor and a wind speed sensor.

9. The controllable and stable sinking/floating system for cage aquaculture of claim 7, wherein the marine environment monitoring host further comprises an operating unit and a storage unit, the second processing module stores the depth signal, the geographic coordinate position signal and the acceleration signal in the storage unit, and the operating unit generates an operating command.

10. The controllable and stable sinking/floating system for cage aquaculture of claim 7, further comprising an onshore processing center, the marine environment monitoring host is installed in the onshore processing center, the onshore processing center is linked to the sinking/floating units via a network, and the depth signal, the geographic coordinate position signal and the acceleration signal are transmitted to the onshore processing center via the network.

11. The controllable and stable sinking/floating system for cage aquaculture of claim 10, further comprising a cloud data center, the cloud data center is linked to the onshore processing center, and the depth signal, the geographic coordinate position signal and the acceleration signal are transmitted via the onshore processing center to the cloud data center for computing.

12. The controllable and stable sinking/floating system for cage aquaculture of claim 7, further comprising an offshore station, the marine environment monitoring host is installed in the offshore station, the sinking/floating units are linked to the offshore station via the network, the depth signal, the geographic coordinate position signal and the acceleration signal are transmitted to the offshore station via the network, and the control signal is transmitted to the sinking/floating units via the network.

13. The controllable and stable sinking/floating system for cage aquaculture of claim 7, further comprising a work boat, the marine environment monitoring host is installed in the work boat, the work boat receives the depth signal, the geographic coordinate position signal and the acceleration signal via the network, and the control signal is transmitted to the sinking/floating units via the network.

14. The controllable and stable sinking/floating system for cage aquaculture of claim 1, further comprising multiple anchors, and each of the anchors is connected to the net cage via a connection part and sunken underwater.

15. The controllable and stable sinking/floating system for cage aquaculture of claim 1, further comprising a counterweight system, and the counterweight system is disposed on a side of the net body being opposite to the frame.
